(19) United States
(12) Patent Application Publication
(10) Pub. No.: US 2026/0361699 A1
(43) Pub. Date: Nov. 12, 2026

(54) SECURE COMMUNICATIONS WITH DYNAMICALLY CHANGING CRYPTOGRAPHIC KEYS USING RANDOM KEY GENERATOR, AND RELATED METHODS AND DEVICES

(71) Applicant: Microchip Technology Incorporated, Chandler, AZ (US)

(72) Inventor: Tik Man Lee, Chandler, AZ (US)

(21) Appl. No.: 19/551,991

(22) Filed: Feb. 27, 2026

Related U.S. Application Data
(60) Provisional application No. 63/770,397, filed on Mar. 12, 2025.

(51) Int. Cl. H04L 9/40; H04L 9/08; H04L 9/30

(52) U.S. Cl. CPC H04L 63/0428; H04L 9/0838; H04L 9/0869; H04L 9/3073

(57) ABSTRACT

A method includes storing a first public key and a first private key of a first public-private key pair; generating a second private key using a random key generator and deriving a second public key based on the second private key, the second public key and the second private key of a second public-private key pair; encrypting transmit data of a first message to a communication device, the transmit data encrypted using at least the first public key or a first shared session key derived at least partially based on the first private key, the transmit data including the second public key; and decrypting receive data of a second message from the communication device, the receive data decrypted using at least the second private key or a second shared session key derived at least partially based on the second private key.

### CROSS-REFERENCE TO RELATED APPLICATIONS

This application claims the benefit under 35 U.S.C. § 119(e) of U.S. Provisional Patent Application Ser. No. 63/770,397, filed Mar. 12, 2025, the disclosure of which is hereby incorporated herein in its entirety by this reference.

### TECHNICAL FIELD

Examples relate, generally, to communications, and more particularly to secure communications, for example, secure communications using dynamically changing cryptographic keys with random key generation, and related methods and devices.

### BACKGROUND

Encrypted communications using a public-private key pair is beneficial because it allows for secure data exchange between parties by ensuring only the intended recipient can decrypt the message, thus protecting sensitive information even if intercepted. In some particular instances, encryption keys of devices may be leaked out during production or manufacturing outsourcing, which increases the risk of the exchange being intercepted or decrypted by unauthorized parties.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1A is a schematic diagram of a system for cryptographic communications between a communication device and a communication device over a communication channel, according to one or more examples;

FIGS. 1B, 1C, 1D, 1E, 1F, 1G, 1H, 1I, and 1J are schematic diagrams of the system of FIG. 1A in respective consecutive processing states associated with communication of a series of cryptographic messages between the devices occurring after the initial state depicted in FIG. 1A;

FIG. 2 is a flowchart of a method of performing cryptographic communications, according to one or more examples;

FIG. 3A is a schematic diagram of a system for cryptographic communications between a communication device and a communication device over a communication channel, according to one or more examples;

FIGS. 3B, 3C, 3D, 3E, 3F, 3G, and 3H are schematic diagrams of the system of FIG. 3A in respective consecutive processing states associated with communication of a series of cryptographic messages between the devices occurring after the initial state depicted in FIG. 3A;

FIG. 4 is a flowchart of a method of performing cryptographic communications, according to one or more examples;

FIG. 5 is a flowchart of a method of performing cryptographic communications, according to one or more examples;

FIG. 6 is a schematic diagram of a communication device, according to one or more examples; and

FIG. 7 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an examples or this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

In a secure communication system (e.g., a secure radio frequency (RF) or wireless communication system), such as an automotive access control system or remote keyless entry system, cryptographic keys initially programmed into communication devices at the factory may be exposed during outsourced manufacturing processes.

In one or more examples of the disclosure, a random key generator of a communication device is used to dynamically change a cryptographic key used for secure communications, such that the initially-programmed cryptographic key will not be useful after one or more communications or transactions. Such a solution increases the difficulty of intercepting communications or forging transactions between two devices. With such a solution, even if the initially-programmed cryptographic key is leaked during manufacturing outsourcing, the system is still under full protection.

In one or more examples, a random key generator is used to create a new cryptographic key or keys for each communication or transaction between the devices. In one or more other examples, the random key generator is used to create a new cryptographic key or keys for each Nth communication or transaction between the devices (e.g., where N=2, 3, or 4, or other). In one or more specific examples, techniques are provided to use the random key generator to create new cryptographic keys where two cryptographic keys are used for cryptographic communications.

As devices can utilize a different cryptographic key or keys over a series of communications, an attempted wireless eavesdropping device will be unable to correctly intercept or forge transactions. The secure cryptographic techniques of the disclosure may be used in automotive, industrial, security, or other suitable applications.

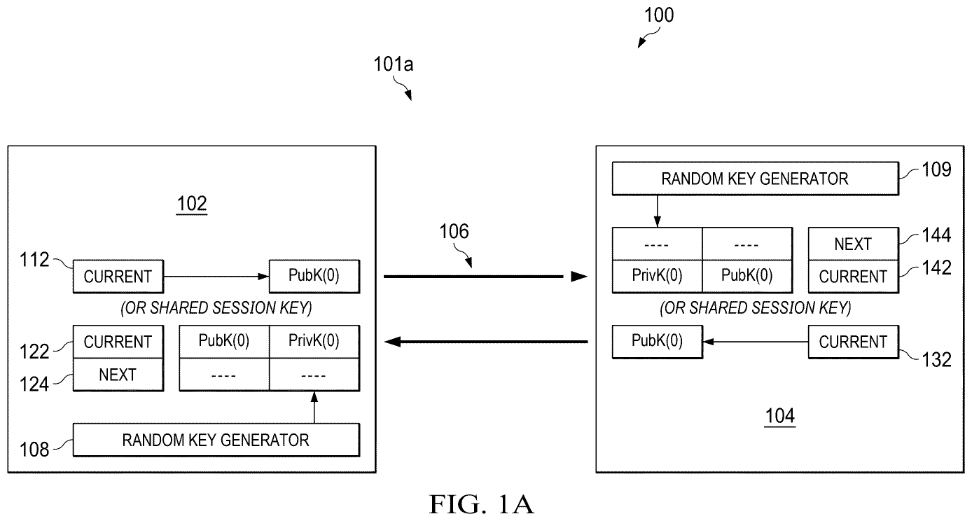

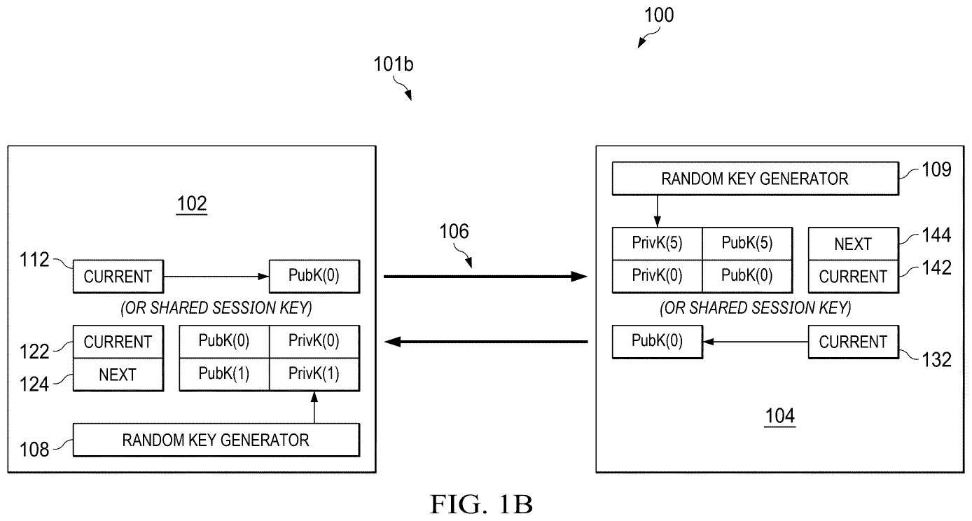

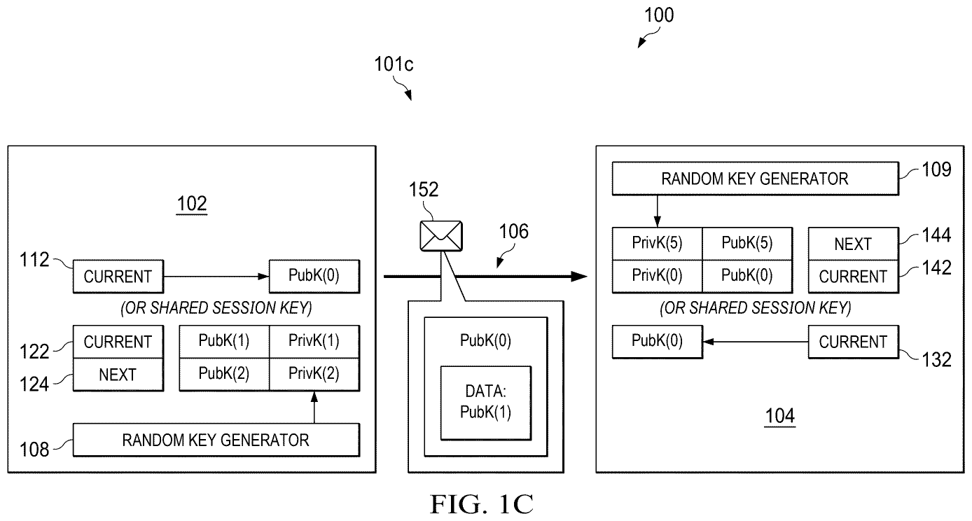

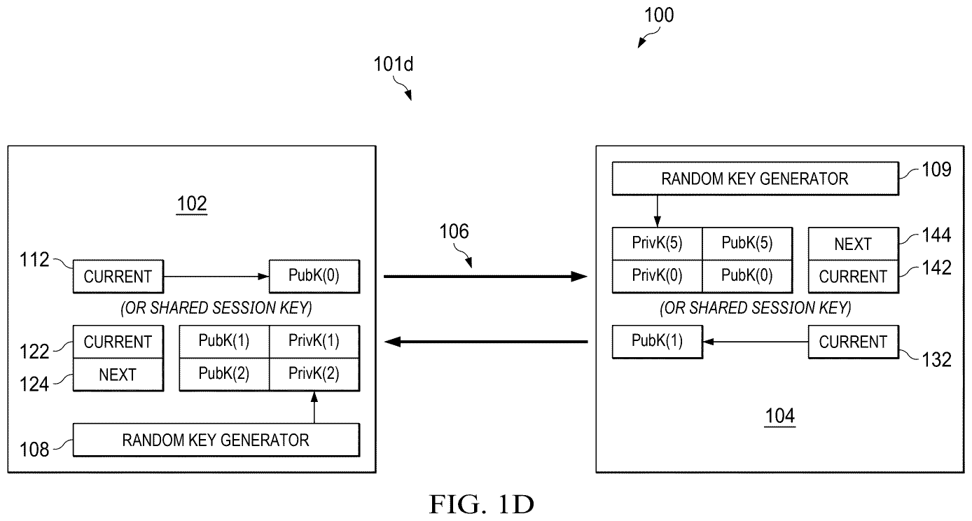

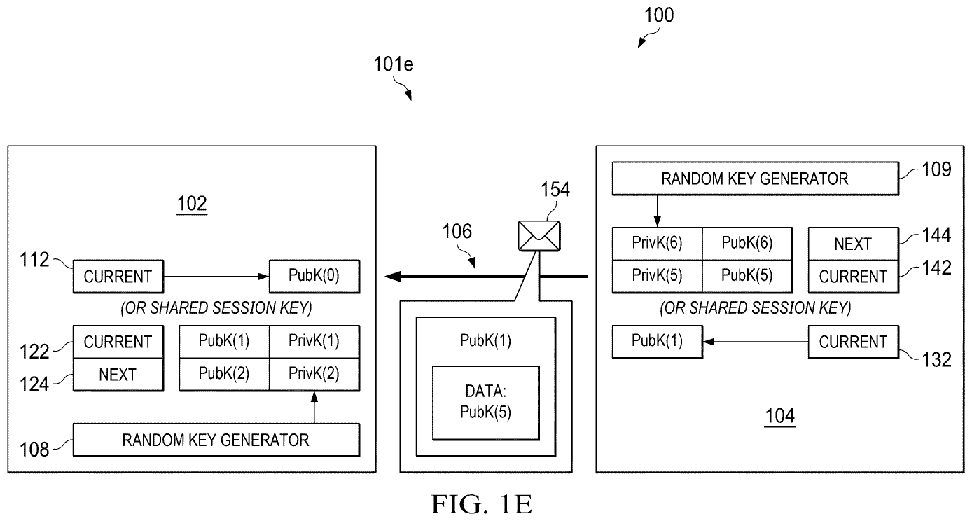

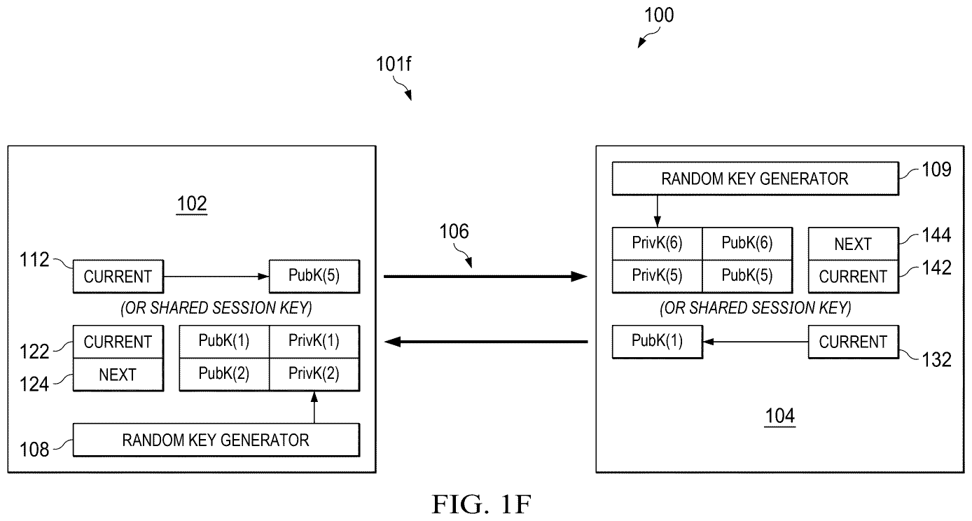

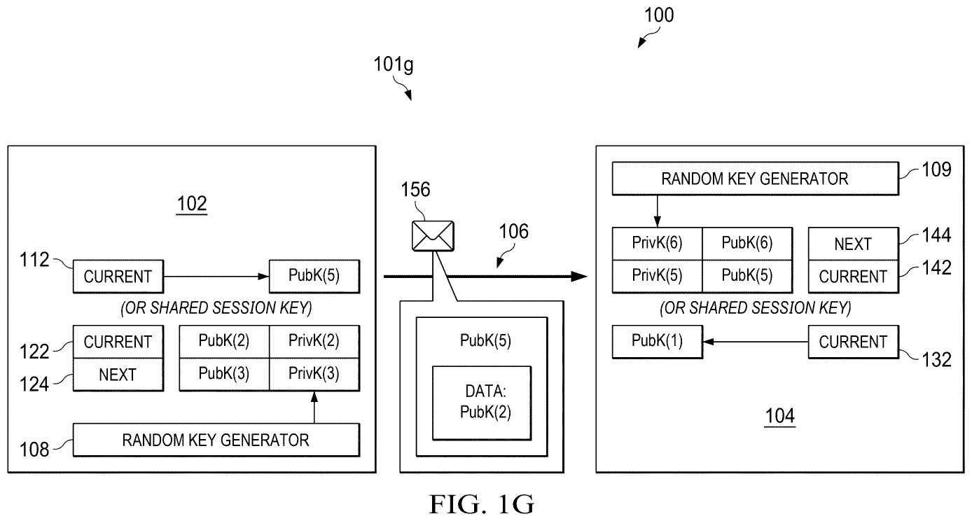

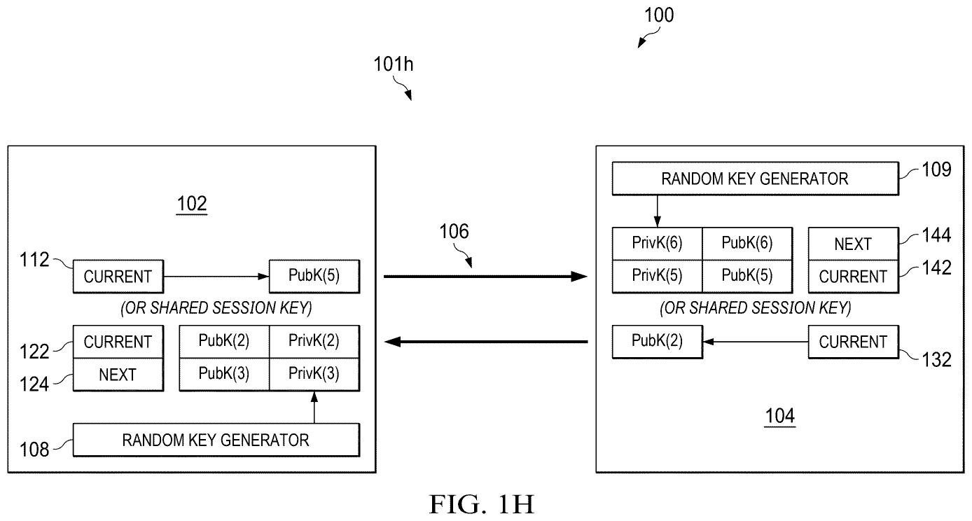

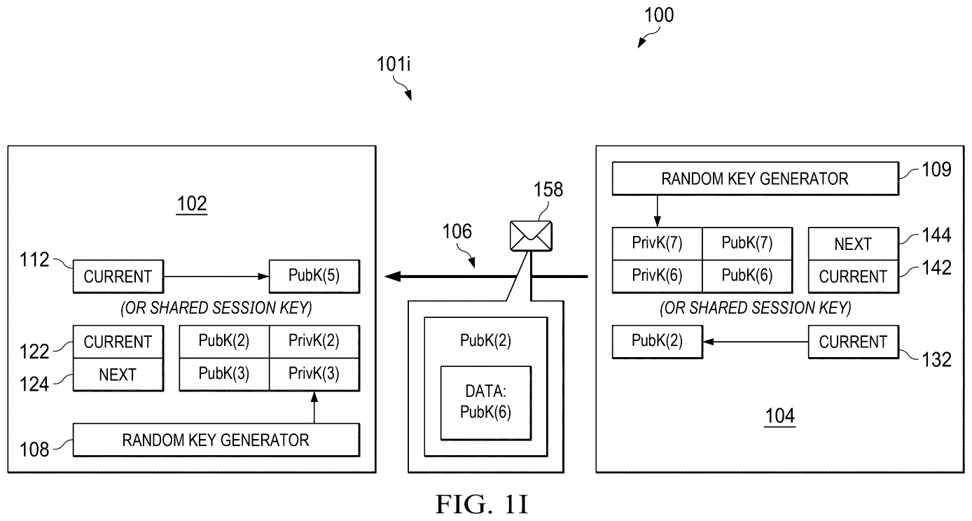

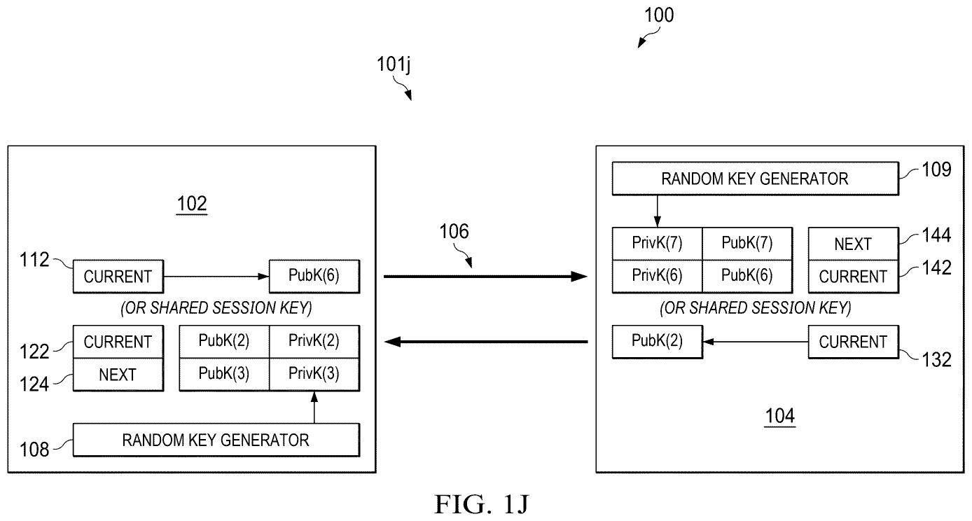

FIG. 1A is a schematic diagram of a system 100 for cryptographic communications between a communication device 102 (a “device 102”) and a communication device 104 (a “device 104”) over a communication channel 106 (a “channel 106”), according to one or more examples. Devices 102 and 104 of system 100 of FIG. 1A are depicted in an initial state 101a before cryptographic communications of messages. In the figures and associated description, “PubK(x)” is used to designate a public key (e.g., of a public-private key pair), where “x” is an integer that distinguishes or uniquely identifies the public key; and “PrivK(y)” is used to designate a private key (e.g., of a public-private key pair), where “y” is an integer that distinguishes or uniquely identifies the private key.

FIGS. 1B, 1C, 1D, 1E, 1F, 1G, 1H, 1I, and 1J are schematic diagrams of system 100 of FIG. 1A in respective consecutive processing states associated with communication of a series of cryptographic messages between devices 102 and 104 occurring after initial state 101a depicted in FIG. 1A.

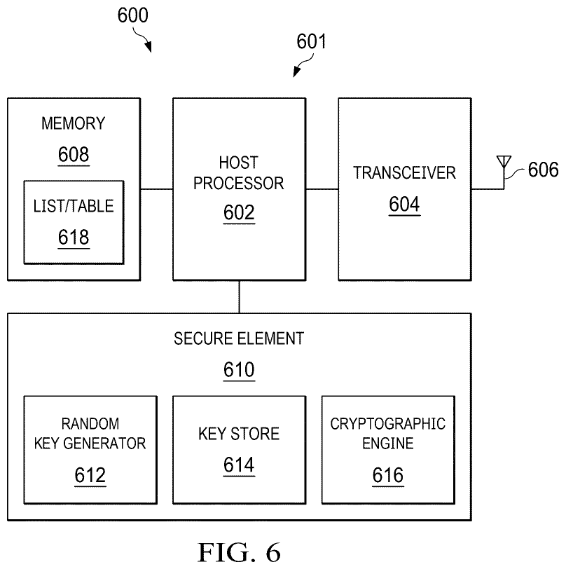

With reference back to FIG. 1A, device 102 includes a random key generator 108 and key slots for storage of cryptographic keys. Similarly, device 104 includes a random key generator 109 and key slots for storage of cryptographic keys. In one or more examples, respective ones of devices 102 and 104 include a secure element having the random key generator and the key slots, as well as a cryptographic engine, as depicted later in relation to FIG. 6.

In device 102, the key slots include a current slot 112 that stores a public key (e.g., PubK(0)) for current encryption, a current slot 122 that stores a public-private key pair which includes a current private key (e.g., PrivK(0)) for current decryption, and a next slot 124 that stores a public-private key pair which includes a private key (not yet specified) for a next or subsequent decryption.

In device 104, the key slots include a current slot 132 that stores a public key (e.g., PubK(0)) for current encryption, a current slot 142 that stores a public-private key pair which includes a current private key (e.g., PrivK(0)) for current decryption, and a next slot 144 that stores a public-private key pair which includes a private key (not yet specified) for next or subsequent decryption.

In one or more examples, devices 102 and 104 are initially programmed with cryptographic keys in the factory or contract manufacturer. Devices 102 and 104 of system 100 of FIG. 1A are depicted in initial state 101a with the initial programming. In initial state 101a, PubK(0) is stored in current slot 112 for encryption of transmit data. In addition, the public-private key pair including PrivK(0) and PubK(0) is stored in current slot 122, PrivK(0) being used for decryption of receive data. Note that the cryptographic keys of devices 102 and 104 could be compromised during factory or contract manufacturing. In one or more examples of the disclosure, concerns about the cryptographic keys being leaked out at the factory or contract manufacturer can be alleviated.

In FIGS. 1B, 1C, 1D, 1E, 1F, 1G, 1H, 1I, and 1J, devices 102 and 104 of system 100 are depicted in respective consecutive processing states associated with communication of a series of cryptographic messages between devices 102 and 104 occurring after initial state 101a of FIG. 1A.

In a processing act 101b of FIG. 1B, device 102 operates random key generator 108 to generate a public-private key pair for storage in a next slot 124. The key pair associated with next slot 124 includes PubK(1) and PrivK(1). In addition, device 104 operates random key generator 109 to generate a public-private key pair for storage in a next slot 144. The key pair associated with next slot 144 includes including PubK(5) and PrivK(5).

In a processing act 101c of FIG. 1C, device 102 transmits a message 152 to device 104 over channel 106. Message 152 includes transmit data encrypted using PubK(0) of current slot 112. As device 102 will use the generated PrivK(1) of current slot 122 for decryption of one or more subsequently received messages, the transmit data of message 152 includes PubK(1) for device 104 to use for encryption. In one or more examples, the transmit data of message 152 indicates an instruction for device 104 to use PubK(1) for encryption. Device 104 receives message 152 from device 102 over channel 106. Device 104 decrypts the receive data from the message using PrivK(0) associated with current slot 142.

In a processing act 101d of FIG. 1D, device 104 extracts PubK(1) from the decrypted data and stores PubK(1) in current slot 132 (e.g., replacing the previous PubK(0)). PubK(1) will be used by device 104 for encryption of subsequent messages.

In a processing act 101e of FIG. 1E, device 104 operates random key generator 109 to generate another public-private key pair for storage in next slot 144. This other key pair that is generated and stored in next slot 144 includes PubK(6) and PrivK(6). The previous key pair including PubK(5) and PrivK(5) is moved to current slot 142. Device 104 will use PrivK(5) of current slot 142 for current decryption of one or more subsequently received messages.

Continuing with processing act 101e of FIG. 1E, device 104 transmits a message 154 to device 102 over channel 106. Message 154 includes transmit data encrypted using PubK(1) of current slot 132. As device 104 will use the generated PrivK(5) of current slot 142 for decryption of one or more subsequently received messages, the transmit data of message 154 includes PubK(5) for device 102 to use for encryption. In one or more examples, the transmit data of message 154 indicates an instruction for device 102 to use PubK(5) for encryption. Device 102 receives message 154 from device 104 over channel 106. Device 102 decrypts the receive data from message 154 using PrivK(1) associated with current slot 122.

In a processing act 101f of FIG. 1F, device 102 extracts PubK(5) from the decrypted data and stores PubK(5) in current slot 112 (e.g., replacing the previous PubK(0)). PubK(5) will be used by device 102 for encryption of subsequent messages.

Continuing in the same manner, in a processing act 101g of FIG. 1G, device 102 operates random key generator 108 to generate another public-private key pair for storage in next slot 124. This other key pair that is generated and stored in next slot 124 includes PubK(3) and PrivK(3). The previous key pair including PubK(2) and PrivK(2) is moved to current slot 122. Device 102 will use PrivK(2) of current slot 122 for current decryption of one or more subsequently received messages.

Continuing with processing act 101g of FIG. 1G, device 102 transmits a message 156 to device 104 over channel 106. Message 156 includes transmit data encrypted using PubK(5) of current slot 112. As device 102 will use the generated PrivK(2) of current slot 122 for decryption of one or more subsequently received messages, the transmit data of message 156 includes PubK(2) for device 104 to use for encryption. In one or more examples, the transmit data of message 156 indicates an instruction for device 104 to use PubK(2) for encryption. Device 104 receives message 156 from device 102 over channel 106. Device 104 decrypts the receive data from message 156 using PrivK(5) associated with current slot 142.

In a processing act 101h of FIG. 1H, device 104 extracts PubK(2) from the decrypted data and stores PubK(2) in current slot 132 (e.g., replacing the previous PubK(1)). PubK(2) will be used by device 104 for encryption of subsequent messages.

In a processing act 101i of FIG. 1I, device 104 operates random key generator 109 to generate another public-private key pair for storage in next slot 144. This other key pair that is generated and stored in next slot 144 includes PubK(7) and PrivK(7). The previous key pair including PubK(6) and PrivK(6) is moved to current slot 142. Device 104 will use PrivK(6) of current slot 142 for current decryption of one or more subsequently received messages.

Continuing with processing act 101i of FIG. 1I, device 104 transmits a message 158 to device 102 over channel 106. Message 158 includes transmit data encrypted using PubK(2) of current slot 132. As device 104 will use the generated PrivK(6) of current slot 142 for decryption of one or more subsequently received messages, the transmit data of message 158 includes PubK(6) for device 102 to use for encryption. In one or more examples, the transmit data of message 158 indicates an instruction for device 102 to use PubK(6) for encryption. Device 102 receives message 158 from device 104 over channel 106. Device 102 decrypts the receive data from message 158 using PrivK(2) associated with current slot 122.

In a processing act 101j of FIG. 1J, device 102 extracts PubK(6) from the decrypted data and stores PubK(6) in current slot 112 (e.g., replacing the previous PubK(5)). PubK(6) will be used by device 102 for encryption of subsequent messages. The processing acts of devices 102 and 104 may continue in the same or similar manner as previously discussed.

This ends the initial discussion of FIGS. 1A, 1B, 1C, 1D, 1E, 1F, 1G, 1H, 1I, and 1J pertaining to the consecutive processing acts associated with the series of cryptographic messages between devices 102 and 104.

In one or more examples of FIGS. 1A, 1B, 1C, 1D, 1E, 1F, 1G, 1H, 1I, and 1J, device 102 operates random key generator 108 to generate private keys that are used for the subsequent generation of shared session keys (e.g., using an Elliptic Curve Diffie-Hellman (ECDH) algorithm) for cryptographic communication between devices 102 and 104. Accordingly, messages between devices 102 and 104 may be encrypted and decrypted using the same shared session key that is generated based on the private key associated with current slot 122 and/or current slot 142 rather than using the randomly-generated private keys themselves.

For generating a shared session key according to one or more examples, device 102 operates random key generator 108 to generate a private key of a public-private key pair and transmits a public key corresponding to the private key to device 104. Device 104 also operates random key generator 109 to generate an ephemeral private key of an ephemeral public-private key pair and transmits an ephemeral public key corresponding to the ephemeral private key to device 102. Device 102 then generates a shared secret based on a key agreement function using, as inputs, the randomly-generated private key and the ephemeral public key received from device 104. Device 102 then derives a shared session key based on a key derivation function (KDF) using, as an input, the shared secret. Similarly, device 104 generates the (same) shared secret based on the key agreement function using, as inputs, the randomly-generated ephemeral private key and the public key received from device 102. Device 104 then derives the (same) shared session key based on the key derivation function (KDF) using, as an input, the shared secret.

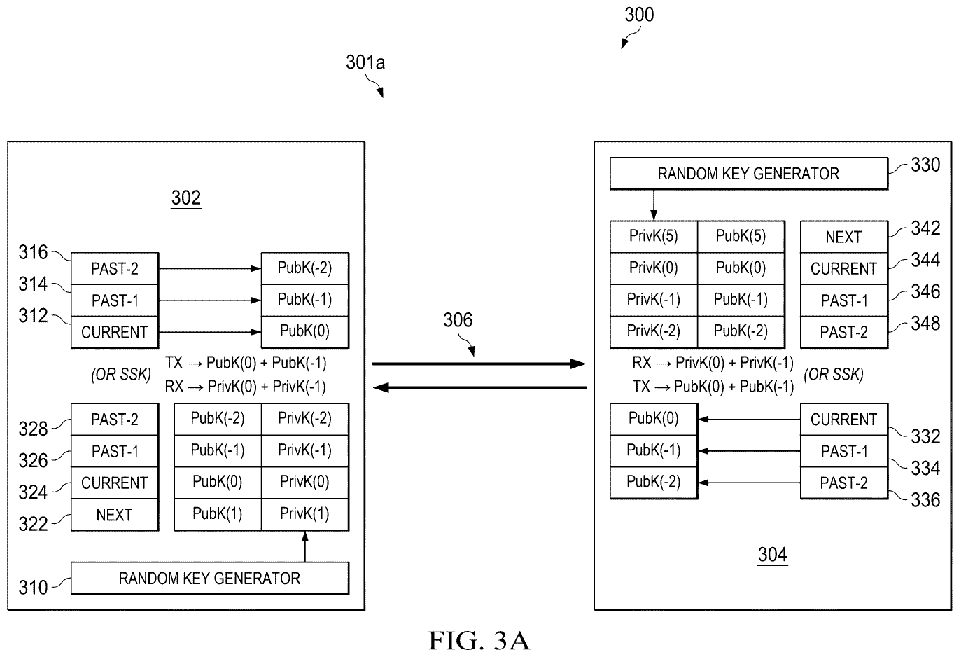

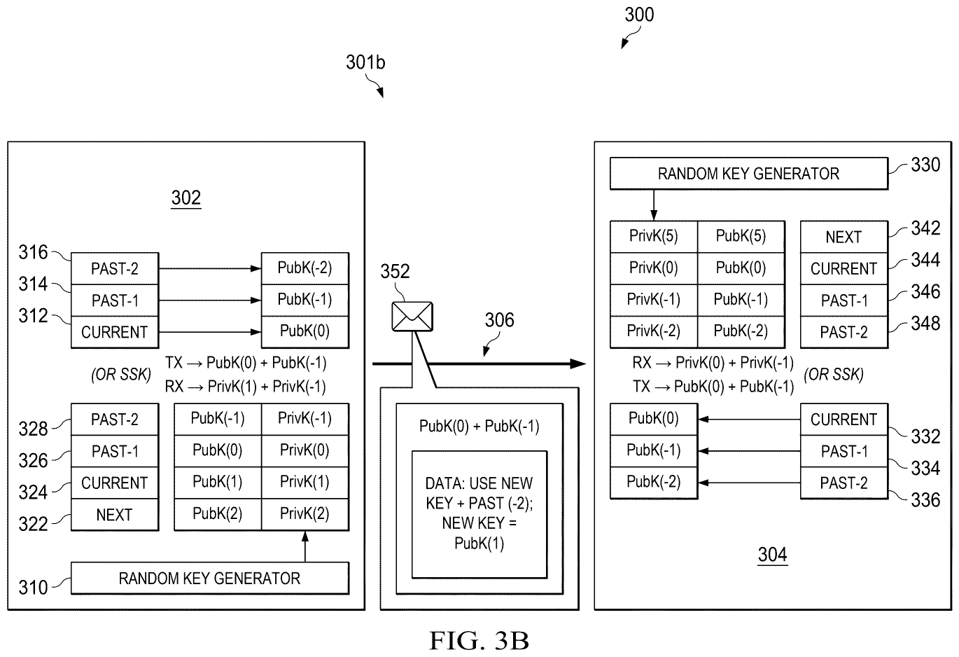

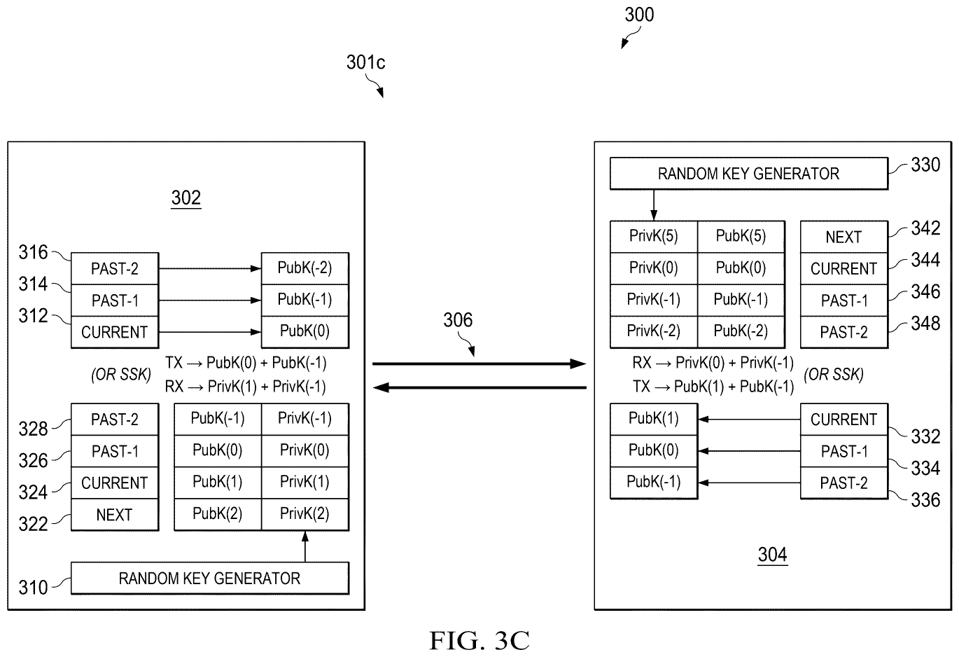

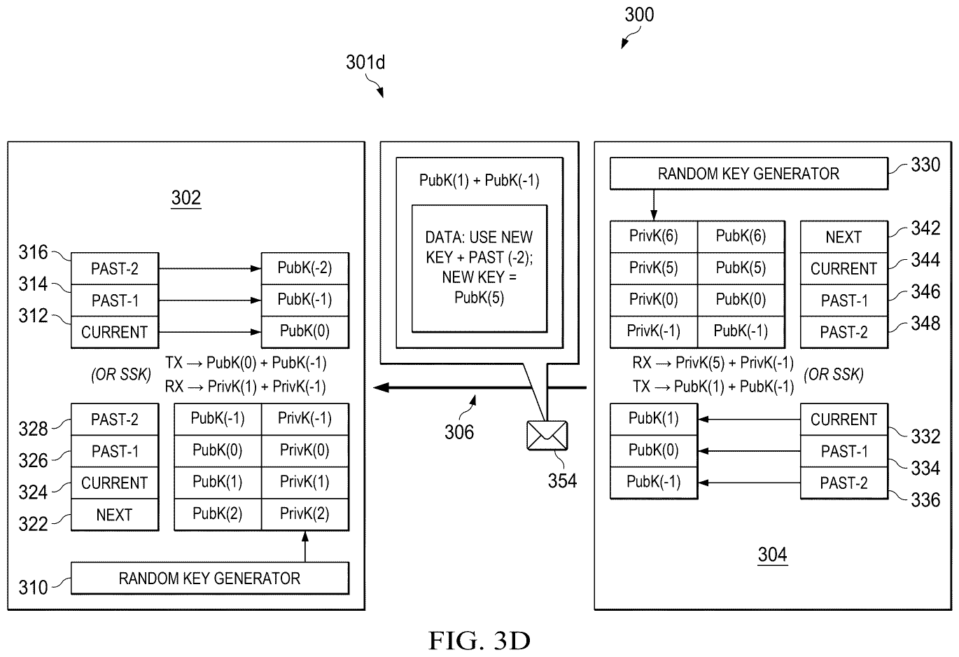

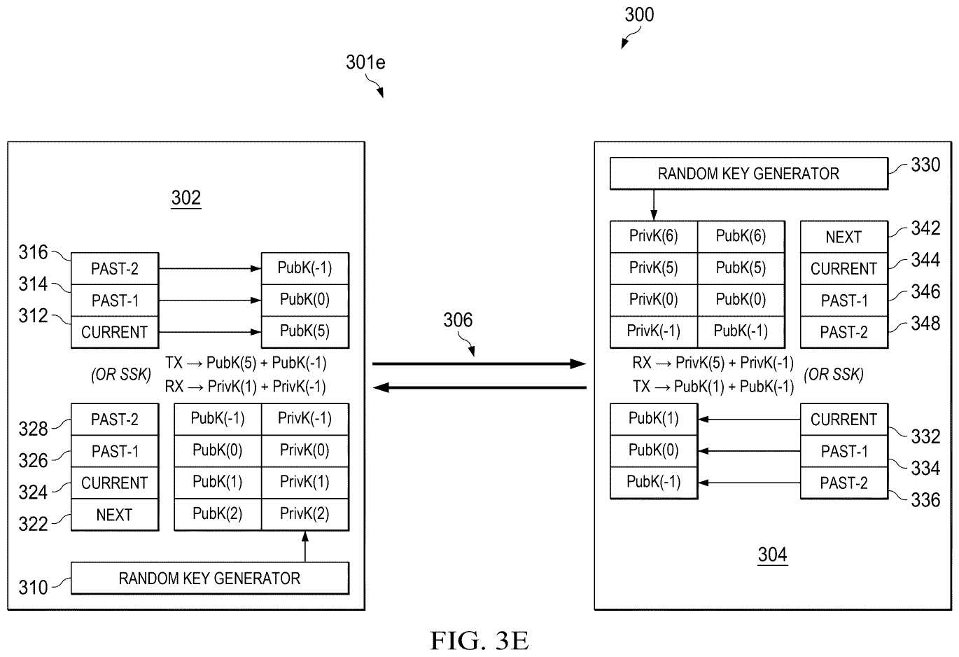

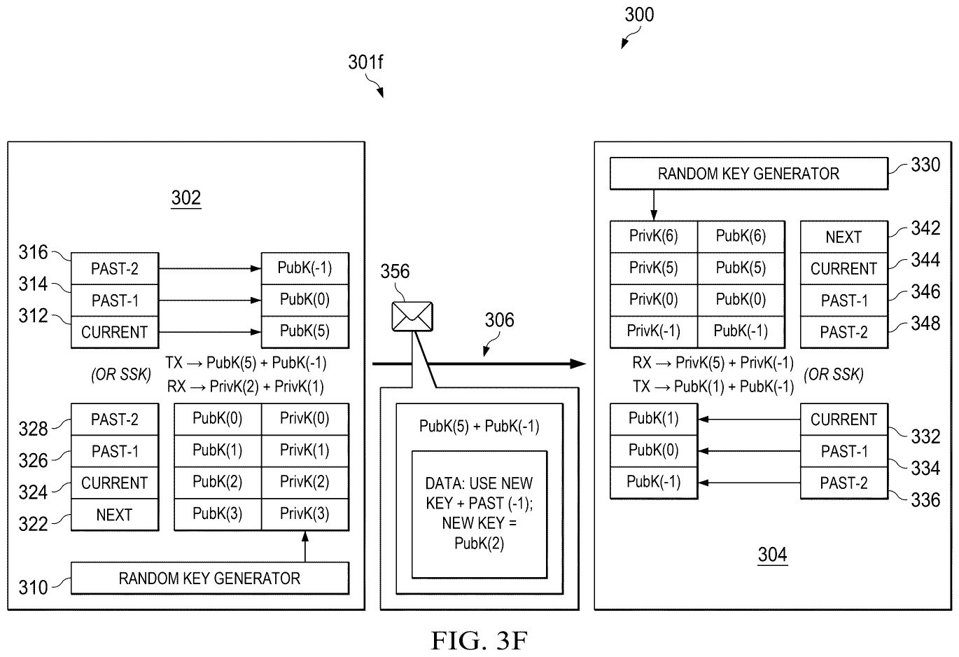

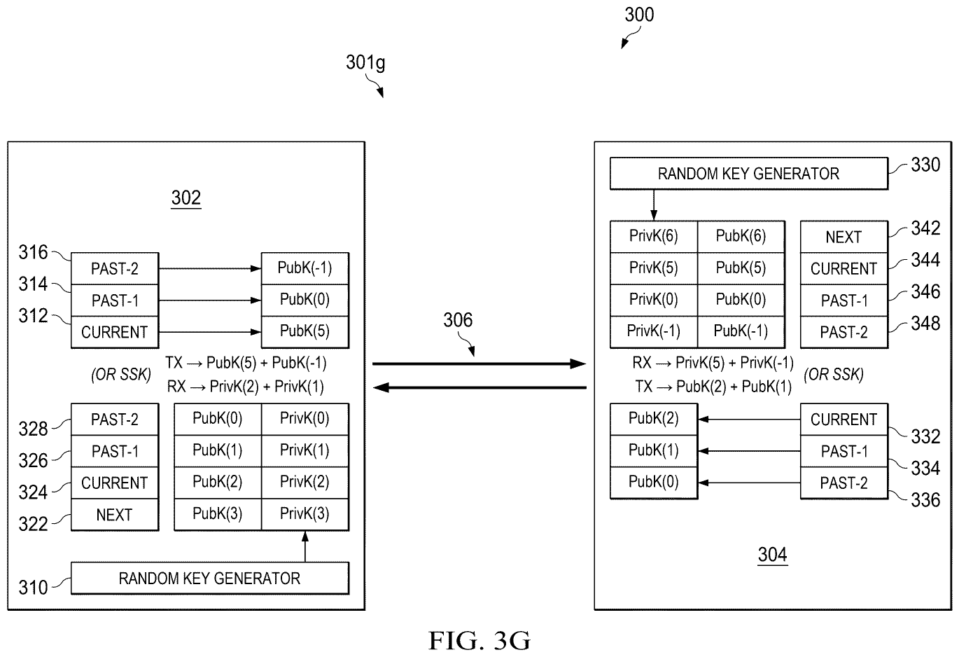

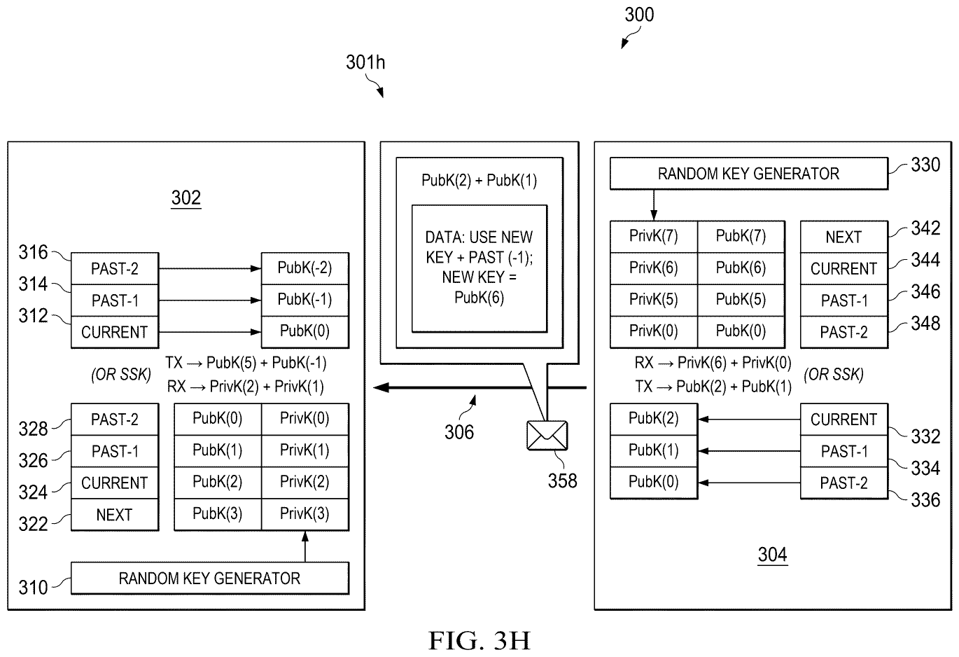

In one or more alternative examples of FIGS. 1A, 1B, 1C, 1D, 1E, 1F, 1G, 1H, 1I, and 1J, device 102 operates random key generator 108 to generate multiple private keys, together with corresponding multiple derived public keys of respective public-private key pairs, and use them in combination for encryption and decryption purposes. In one or more examples, a layered or double encryption/decryption approach utilizing a combination of keys may be taken. Here, in one or more examples, a device transmits a message including a public key and an identifier to identify a selected one of a number of public keys already stored at the receiving device, together with data indicating an instruction to use both keys for encryption purposes. In one or more examples, selection of the selected one of the number of stored public keys is performed by the device randomly or pseudo-randomly (even deterministically, for example, if sufficiently random or pseudo-random). Examples of use of a combination of keys for encryption and decryption is discussed in more detail later in relation to FIGS. 3A, 3B, 3C, 3D, 3E, 3F, 3G, and 3H.

Again, in one or more examples, a layered or double encryption/decryption approach utilizing a combination of keys may be taken. As one example of a layered or double encryption/decryption approach, transmit data (which is, for example, original plaintext) is encrypted a first time using a first encryption key to provide a resulting ciphertext, and the resulting ciphertext is encrypted a second time using a second encryption key to provide a resulting double-ciphertext. For decryption, the recipient can use the corresponding decryption keys in the correct, reverse sequence. Here, the receive data (which is, for example, the double-ciphertext) is decrypted a first time using a first decryption key to provide a resulting ciphertext, and the resulting ciphertext is decrypted a second time using a second decryption key to provide the resulting original plaintext.

In one or more alternative examples of FIGS. 1A, 1B, 1C, 1D, 1E, 1F, 1G, 1H, 1I, and 1J, the messages between devices 102 and 104 may be encrypted and decrypted using a shared session key (e.g., using an ECDH algorithm) generated based on a combination of generated keys rather than be encrypted and decrypted using the combination of private keys themselves. For generating a shared session key based on a combination of keys according to one or more examples, after random generation of a private key, device 102 transmits a message including a corresponding public key and an identifier to identify a selected one of a number of public keys that are already stored at device 104. In one or more examples, selection of the selected one of the number of stored public keys is performed by device 102 randomly or pseudo-randomly (even deterministically, for example, if sufficiently random or pseudo-random). The information may be transmitted together with data indicating an instruction to use both keys for derivation of the shared session key. In response, device 104 operates random key generator 109 to generate an ephemeral private key of an ephemeral public-private key pair and transmits an ephemeral public key corresponding to the ephemeral private key to device 102. Device 104 then generates a first shared secret based on a key agreement function using, as inputs, the ephemeral private key and the public key received from device 102. Device 104 also generates a second shared secret based on the key agreement function using, as inputs, the ephemeral private key and the selected one of the number of stored keys identified by the identifier. Device 104 then derives a shared session key based on a KDF using, as inputs, the first shared secret and the second shared secret. Device 102 also generates a first shared secret based on the key agreement function using, as inputs, the randomly-generated private key and the ephemeral public key received from device 104. Device 102 also generates a second shared secret based on the key agreement function using, as inputs, a selected one of the number of private keys corresponding to the identifier and the ephemeral public key received from device 104. Device 102 then derives the shared session key based on the KDF using, as inputs, the first shared secret and the second shared secret.

A wireless eavesdropping or “sniffer” device may obtain or copy a cryptographic key of a secure communication system (e.g., a remote keyless entry system). In one or more examples of the disclosure, however, even if the wireless eavesdropping device is able to sniff one communication, it is not likely to be able to sniff another subsequent communication. In this type of the system, the wireless eavesdropper would need multiple wireless sniffing mechanisms to break into the system.

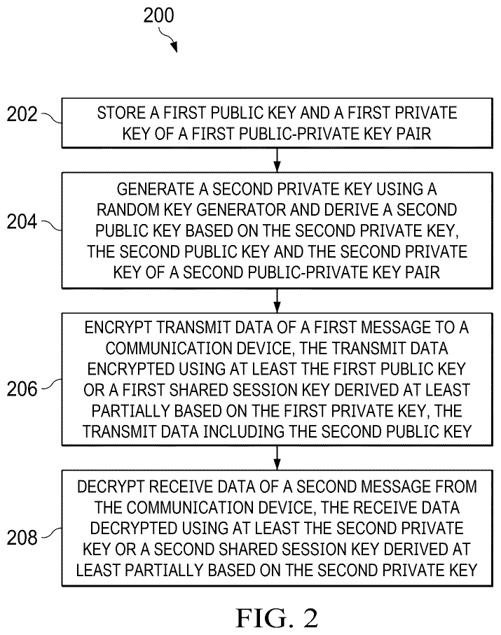

FIG. 2 is a flowchart of a method 200 of performing cryptographic communications, according to one or more examples. Method 200 of FIG. 2 may be performed at a communication device, such as device 102 of FIGS. 1A, 1B, 1C, 1D, 1E, 1F, 1G, 1H, 1I, and 1J. Although method 200 of FIG. 2 is described as being performed at device 102, it may be alternatively or additionally performed at device 104 of FIGS. 1A, 1B, 1C, 1D, 1E, 1F, 1G, 1H, 1I, and 1J. In one or more examples, the device used for method 200 of FIG. 2 may include one or more processors, one or more memories operably coupled to the one or more processors, and a transceiver (e.g., an RF or wireless transceiver) operably coupled to the one or more processors. The one or more processors may include a host processor and both a secure processor and a cryptographic processor of a secure element, the secure element further including a random key generator and a key store.

At an act 202, the device stores a first public key and a first private key of a first public-private key pair. At an act 204, the device generates a second private key using a random key generator and derives a second public key based on the second private key, the second public key and the second private key being of a second public-private key pair. At an act 206, the device encrypts transmit data of a first message to a communication device. The transmit data are encrypted using at least the first public key. Alternatively, the transmit data are encrypted using a first shared session key derived at least partially based on the first private key. The transmit data includes the second public key. At an act 208, the device decrypts receive data of a second message from the communication device. The receive data are decrypted using at least the second private key. Alternatively, the receive data are decrypted using a second shared session key derived at least partially based on the second private key.

In one or more examples of method 200, the device generates a third private key using the random key generator and derives a third public key based on the third private key, the third public key and the third private key being of a third public-private key pair. The device encrypts the transmit data of a third message to the communication device. The transmit data are encrypted using at least the second public key. Alternatively, the transmit data are encrypted using the second shared session key. The transmit data include the third public key.

In one or more examples, the device decrypts receive data of a fourth message from the communication device. The receive data are decrypted using at least the third private key. Alternatively, the receive data are decrypted using a third shared session key derived at least partially based on the third private key.

In one or more examples, the transmit data of the first message is encrypted using the first shared session key, the receive data of the second message is decrypted using the second shared session key, the transmit data of the third message is encrypted using the second shared session key, and the receive data of the fourth message is decrypted using the third shared session key. Here, the device derives the second shared session key by generating a shared secret based on a key agreement function using, as inputs, at least the second private key and an ephemeral public key received from the communication device; and deriving the second shared session key based on a key agreement function using, as an input, at least the shared secret.

In one or more examples, the transmit data of the first message are encrypted using at least the first public key, the receive data of the second message are decrypted using at least the second private key, the transmit data of the third message are encrypted using at least the second public key, and the receive data of the fourth message are decrypted using at least the third private key. Here, the device encrypts the transmit data of the third message by encrypting the transmit data including the third public key and an identifier to identify a selected one of a number of stored public keys at the communication device, the number of stored public keys including the first public key and the second public key; and decrypting receive data of the fourth message includes producing decrypted receive data, the decrypted receive data decrypted using both the third private key and a selected one of a number of stored private keys in accordance with a layered (or double) encryption/decryption protocol, the selected one of the number of stored private keys corresponding to the selected one of the number of stored public keys, the number of stored private keys including the first private key and the second private key.

In one or more examples, the transmit data of the first message are encrypted using the first shared session key, the receive data of the second message is decrypted using the second shared session key, the transmit data of the third message is encrypted using the second shared session key, and the receive data of the fourth message is decrypted using the third shared session key. Here, the device encrypts the transmit data of the third message by encrypting the transmit data including the third public key and an identifier to identify a selected one of a number of stored public keys at the communication device, the number of stored public keys including the first public key and the second public key; and deriving the third shared session key at least partially based on the third private key and a selected one of a number of stored private keys, the selected one of the number of stored private keys corresponding to the selected one of the number of stored public keys, the number of stored private keys including the first private key and the second private key.

In one or more examples, the device derives the third shared session key by generating a first shared secret based on a key agreement function using, as inputs, at least the third private key and an ephemeral public key received from the communication device; generating a second shared secret based on the key agreement function using, as inputs, at least the selected one of the number of stored private keys and the ephemeral public key received from the communication device; and deriving the third shared session key based on a key derivation function using, as inputs, at least the first shared secret and the second shared secret.

FIG. 3A is a schematic diagram of a system 300 for cryptographic communications between a communication device 302 (a “device 302”) and a communication device 304 (a “device 304”) over a communication channel 306 (a “channel 306”), according to one or more examples. Devices 302 and 304 of system 300 of FIG. 3A are depicted in an initial state 301a before cryptographic communications of messages.

FIGS. 3B, 3C, 3D, 3E, 3F, 3G, and 3H are schematic diagrams of system 300 of FIG. 3A in respective consecutive processing states associated with communication of a series of cryptographic messages between devices 302 and 304 occurring after initial state 301a depicted in FIG. 3A.

With reference back to FIG. 3A, device 302 includes a random key generator 310 and key slots for storage of cryptographic keys. Similarly, device 304 includes a random key generator 330 and key slots for storage of cryptographic keys. In one or more examples, respective ones of devices 302 and 304 include a secure element having the random key generator and the key slots, as well as a cryptographic engine, as depicted later in relation to FIG. 6.

In device 302, the key slots include a current slot 312 that stores a current public key (e.g., PubK(0)) for current encryption, a past-1 slot 314 that stores another public key (e.g., PubK(−1)) for past encryption, and a past-2 slot 316 that stores yet another public key (e.g., PubK(−2)) for past encryption. The key slots of device 302 also include a current slot 324 that stores a current public-private key pair which includes a current private key (e.g., PrivK(0)) for current decryption, and a next slot 322 that stores a next public-private key pair which includes a private key (e.g., PrivK(1)) for a next or subsequent decryption. The key slots of device 302 also include a past-1 slot 326 that stores a past public-private key pair which includes a private key (e.g., PrivK(−1)) for past decryption and a past-2 slot 328 that stores another past public-private key pair which includes yet another private key (e.g., PrivK(−2)) for past decryption.

In device 304, the key slots include a current slot 332 that stores a current public key (e.g., PubK(0)) for current encryption, a past-1 slot 334 that stores another public key (e.g., PubK(−1)) for past encryption, and a past-2 slot 336 that stores yet another public key (e.g., PubK(−2)) for past encryption. The key slots of device 304 also include a current slot 344 that stores a current public-private key pair which includes a current private key (e.g., PrivK(0)) for current decryption, and a next slot 342 that stores a next public-private key pair which includes a private key (e.g., PrivK(5)) for a next or subsequent decryption. The key slots of device 304 also include a past-1 slot 346 that stores a past public-private key pair which includes a private key (e.g., PrivK(−1)) for past decryption and a past-2 slot 348 that stores another past public-private key pair which includes yet another private key (e.g., PrivK(−2)) for past decryption.

In one or more examples, devices 302 and 304 are initially programmed with the cryptographic keys in the factory or contract manufacturer. Devices 302 and 304 of system 300 of FIG. 3A are depicted in initial state 301a with the initial programming. In initial state 301a, PubK(0) of current slot 312 and PubK(−1) of past-1 slot 314 are used in combination for encryption of transmit data (e.g., for transmit or “Tx”). In addition, the public-private key pair including PubK(0) and PrivK(0) of current slot 324, and the other public-private key pair including PubK(−1) and PrivK(−1) of past-1 slot 326, include PrivK(0) and PrivK(−1) used in combination for decryption of receive data (e.g., for receive or “Rx”). Note that the cryptographic keys of devices 302 and 304 could be compromised during factory or contract manufacturing. In one or more examples of the disclosure, concerns about the cryptographic keys being leaked out at the factory or contract manufacturer can be alleviated.

In FIGS. 3B, 3C, 3D, 3E, 3F, 3G, and 3H, devices 302 and 304 of system 300 are depicted in respective consecutive processing states associated with communication of a series of cryptographic messages between devices 302 and 304 occurring after initial state 301a of FIG. 3A.

In a processing act 301b of FIG. 3B, device 302 operates random key generator 310 to generate a public-private key pair for storage in next slot 322. The key pair associated with next slot 322 includes PubK(2) and PrivK(2). The previous key pair including PubK(1) and PrivK(1) is moved to current slot 324, and similarly for PubK(0) and PrivK(0) to past-1 slot 326 and PubK(−1) and PrivK(−1) to past-2 slot 328. Device 302 will use the combination of PrivK(1) of current slot 324 and PrivK(−1) of past-2 slot 328 for decryption (Rx) of one or more subsequently received messages.

Continuing with processing act 301b of FIG. 3B, device 302 transmits a message 352 to device 304 over channel 306. Message 352 includes transmit data encrypted using the combination of PubK(0) of current slot 312 and PubK(−1) of past-1 slot 314. As device 302 will use the combination of PrivK(1) of current slot 324 and PrivK(−1) of past-2 slot 328 for decryption (Rx) of one or more subsequently received messages, the transmit data of message 352 includes PubK(1) and an identifier to identify a selected one of a number of public keys stored at device 304 (e.g., keys stored in key slots 332, 334, and 336), where the identifier is to identify the public key in the past-2 slot of device 304. In one or more examples, selection of the selected one of the number of stored public keys is performed by device 302 randomly or pseudo-randomly (or even deterministically). In one or more examples, the information is provided together with data indicating an instruction to use both keys in combination for encryption purposes. Device 304 receives message 352 from device 302 over channel 306. Device 304 decrypts the receive data from message 352 using the combination of PrivK(0) of current slot 344 and PrivK(−1) of past-1 slot 346 set for decryption (Rx).

In a processing act 301c of FIG. 3C, device 304 extracts PubK(1) from the decrypted data and stores PubK(1) in current slot 332. PubK(0) is moved to past-1 slot 334 and PubK(−1) is moved to past-2 slot 336. In addition, device 304 uses the identifier to identify the selected one of the number of stored public keys associated with past-2 slot 336, which is PubK(−1). In response to the instruction, device 304 sets the combination of PubK(1) of current slot 332 and PubK(−1) of past-2 slot 336 for encryption (Tx).

In a processing act 301d of FIG. 3D, device 304 operates random key generator 330 to generate another public-private key pair for storage in next slot 342. This other key pair that is generated and stored in next slot 342 includes PubK(6) and PrivK(6). The previous key pair including PubK(5) and PrivK(5) is moved to current slot 344, and similarly for the previous key pairs including PubK(0) and PrivK(0) to past-1 slot 346 and PubK(−1) and PrivK(−1) to past-2 slot 348. Device 304 will use the combination of PrivK(5) of current slot 344 and PrivK(−1) of past-2 slot 348 for current decryption (Rx) of one or more subsequently received messages.

Continuing with processing act 301d of FIG. 3D, device 304 transmits a message 354 to device 302 over channel 306. Message 354 includes transmit data encrypted using the combination of PubK(1) of current slot 332 and PubK(−1) of past-2 slot 336 per the previous instruction issued. As device 304 will use the combination of PrivK(5) of current slot 344 and PrivK(−1) of past-2 slot 348 for decryption (Rx) of one or more subsequently received messages, the transmit data of message 354 includes PubK(5) and an identifier to identify a selected one of a number of public keys stored at device 302 (e.g., keys stored in key slots 312, 314, and 316), where the identifier is to identify the public key in the past-2 slot of device 302. In one or more examples, selection of the selected one of the number of stored public keys is performed by device 304 randomly or pseudo-randomly (even deterministically). In one or more examples, the information is provided together with data indicating an instruction to use both keys in combination for encryption purposes. Device 302 receives message 354 from device 304 over channel 306. Device 302 decrypts the receive data from message 354 using the combination of PrivK(1) of current slot 324 and PrivK(−1) of past-2 slot 328 set for decryption (Rx).

In a processing act 301e of FIG. 3E, device 302 extracts PubK(5) from the decrypted data and stores PubK(5) in current slot 312. PubK(0) is moved to past-1 slot 314 and PubK(−1) is moved to past-2 slot 316. In addition, device 302 uses the identifier to identify the selected one of the number of stored public keys associated with past-2 slot 316, which is PubK(−1). In response to the instruction, device 302 sets the combination of PubK(5) of current slot 312 and PubK(−1) of past-2 slot 316 for encryption (Tx).

In a processing act 301f of FIG. 3F, device 302 operates random key generator 310 to generate a public-private key pair for storage in next slot 322. The key pair associated with next slot 322 includes PubK(3) and PrivK(3). The previous key pair including PubK(2) and PrivK(2) is moved to current slot 324, and similarly for PubK(1) and PrivK(1) to past-1 slot 326 and PubK(0) and PrivK(0) to past-2 slot 328. Device 302 will use the combination of PrivK(2) of current slot 324 and PrivK(1) of past-1 slot 326 for decryption (Rx) of one or more subsequently received messages.

Continuing with processing act 301f of FIG. 3F, device 302 transmits a message 356 to device 304 over channel 306. Message 356 includes transmit data encrypted using the combination of PubK(5) of current slot 312 and PubK(−1) of past-2 slot 316. As device 302 will use the combination of PrivK(2) of current slot 324 and PrivK(1) of past-1 slot 326 for decryption (Rx) of one or more subsequently received messages, the transmit data of message 356 includes PubK(2) and an identifier to identify a selected one of a number of public keys stored at device 304 (e.g., keys stored in key slots 332, 334, and 336), where the identifier is to identify the public key in the past-1 slot of device 304. In one or more examples, selection of the selected one of the number of stored public keys is performed by device 302 randomly or pseudo-randomly (even deterministically, for example, if sufficiently random or pseudo-random). In one or more examples, the information is provided together with data indicating an instruction to use both keys in combination for encryption purposes. Device 304 receives message 356 from device 302 over channel 306. Device 304 decrypts the receive data from message 356 using the combination of PrivK(5) of current slot 344 and PrivK(−1) of past-2 slot 348 set for decryption (Rx).

In a processing act 301g of FIG. 3G, device 304 extracts PubK(2) from the decrypted data and stores PubK(2) in current slot 332. PubK(1) is moved to past-1 slot 334 and PubK(0) is moved to past-2 slot 336. In addition, device 304 uses the identifier to identify the selected one of the number of stored public keys associated with past-1 slot 334, which is PubK(1). In response to the instruction, device 304 sets the combination of PubK(2) of current slot 332 and PubK(1) of past-1 slot 334 for encryption (Tx).

In a processing act 301h of FIG. 3H, device 304 operates random key generator 330 to generate another public-private key pair for storage in next slot 342. This other key pair that is generated and stored in next slot 342 includes PubK(7) and PrivK(7). The previous key pair including PubK(6) and PrivK(6) is moved to current slot 344, and similarly for the previous key pairs including PubK(5) and PrivK(5) to past-1 slot 346 and PubK(0) and PrivK(0) to past-2 slot 348. Device 304 will use the combination of PrivK(6) of current slot 344 and PrivK(0) of past-2 slot 348 for current decryption (Rx) of one or more subsequently received messages.

Continuing with processing act 301h of FIG. 3H, device 304 transmits a message 358 to device 302 over channel 306. Message 358 includes transmit data encrypted using the combination of PubK(2) of current slot 332 and PubK(1) of past-1 slot 334 per the previous instruction issued. As device 304 will use the combination of PrivK(6) of current slot 344 and PrivK(0) of past-2 slot 348 for decryption (Rx) of one or more subsequently received messages, the transmit data of message 358 includes PubK(6) and an identifier to identify a selected one of a number of public keys stored at device 302 (e.g., keys stored in key slots 312, 314, and 316), where the identifier is to identify the public key in the past-1 slot of device 302 (which will be PubK(0)). In one or more examples, selection of the selected one of the number of stored public keys is performed by device 304 randomly or pseudo-randomly (even deterministically). In one or more examples, the information is provided together with data indicating an instruction to use both keys in combination for encryption purposes. Device 302 receives message 358 from device 304 over channel 306. Device 302 decrypts the receive data from message 358 using the combination of PrivK(2) of current slot 324 and PrivK(1) of past-1 slot 326 set for decryption (Rx). Device 302 will then extract PubK(5) from the decrypted data and store PubK(5) in current slot 312, and so on, and use the identifier to identify the selected one of the number of stored public keys, and so on, to set the combination of PubK(6) and PubK(0) for encryption (Tx).

This ends the initial discussion of FIGS. 3A, 3B, 3C, 3D, 3E, 3F, 3G, and 3H pertaining to the consecutive processing acts associated with the series of cryptographic messages between devices 302 and 304.

In one or more examples of FIGS. 3A, 3B, 3C, 3D, 3E, 3F, 3G, and 3H, device 302 and/or device 304 may operate its random key generator to generate keys used in combination for encryption and decryption purposes. In one or more examples, a layered or double encryption/decryption approach utilizing a combination of keys may be taken. As one example of a layered or double encryption/decryption approach, transmit data (which is, for example, original plaintext) is encrypted a first time using a first encryption key to provide a resulting ciphertext, and the resulting ciphertext is encrypted a second time using a second encryption key to provide a resulting double-ciphertext. For decryption, the recipient can use the corresponding decryption keys in the correct, reverse sequence. Here, the receive data (which is, for example, the double-ciphertext) is decrypted a first time using a first decryption key to provide a resulting ciphertext, and the resulting ciphertext is decrypted a second time using a second decryption key to provide the resulting original plaintext.

In one or more alternative examples of FIGS. 3A, 3B, 3C, 3D, 3E, 3F, 3G, and 3H, the messages between devices 302 and 304 may be encrypted and decrypted using a shared session key (e.g., using an ECDH algorithm) generated based on a combination of generated keys rather than be encrypted and decrypted using the combination of private keys themselves. For generating a shared session key based on a combination of keys according to one or more examples, after random generation of a private key, device 302 transmits a message including a corresponding public key and an identifier to identify a selected one of a number of public keys that are already stored at device 304. In one or more examples, selection of the selected one of the number of stored public keys is performed by device 302 randomly or pseudo-randomly (even deterministically, for example, if sufficiently random or pseudo-random). The information may be transmitted together with data indicating an instruction to use both keys for derivation of the shared session key. In response, device 304 operates random key generator 330 to generate an ephemeral private key of an ephemeral public-private key pair and transmits an ephemeral public key corresponding to the ephemeral private key to device 302. Device 304 then generates a first shared secret based on a key agreement function using, as inputs, the ephemeral private key and the public key received from device 302. Device 304 also generates a second shared secret based on the key agreement function using, as inputs, the ephemeral private key and the selected one of the number of stored keys identified by the identifier. Device 304 then derives a shared session key based on a KDF using, as inputs, the first shared secret and the second shared secret. Device 302 also generates a first shared secret based on the key agreement function using, as inputs, the randomly-generated private key and the ephemeral public key received from device 304. Device 302 also generates a second shared secret based on the key agreement function using, as inputs, a selected one of the number of private keys corresponding to the identifier and the ephemeral public key received from device 304. Device 302 then derives the shared session key based on the KDF using, as inputs, the first shared secret and the second shared secret.

Again, a wireless eavesdropping or “sniffer” device may obtain or copy a cryptographic key of a secure communication system (e.g., a remote keyless entry system). In one or more examples of the disclosure, however, even if the wireless eavesdropping device is able to sniff one communication, it is not likely to be able to sniff another subsequent communication. In this type of the system, the wireless eavesdropper would need multiple wireless sniffing mechanisms to break into the system.

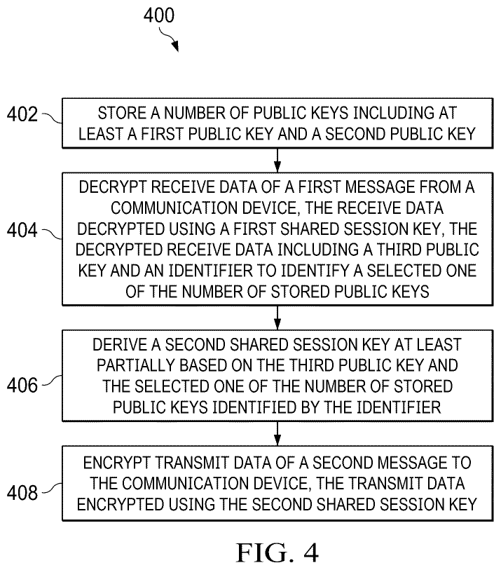

FIG. 4 is a flowchart of a method 400 of performing cryptographic communications, in one or more examples. Method 400 of FIG. 4 may be performed at a communication device, such as device 302 of FIGS. 3A, 3B, 3C, 3D, 3E, 3F, 3G, and 3H. Although method 400 of FIG. 4 is described as being performed at device 302, it may be alternatively or additionally performed at device 304 of FIGS. 3A, 3B, 3C, 3D, 3E, 3F, 3G, and 3H. In one or more examples, the device used for method 400 of FIG. 4 may include one or more processors, one or more memories operably coupled to the one or more processors, and a transceiver (e.g., an RF or wireless transceiver) operably coupled to the one or more processors. The one or more processors may include a host processor and both a secure processor and a cryptographic processor of a secure element, where the secure element further includes a random key generator and a key store.

At an act 402, the device stores a number of public keys including at least a first public key and a second public key. At an act 404, the device decrypts receive data of a first message from a communication device. The receive data are decrypted using a first shared session key. The decrypted receive data include a third public key and an identifier to identify a selected one of the number of stored public keys. In one or more examples, the device selects the selected one of the number of stored public keys randomly, pseudo-randomly, or deterministically from the number of stored public keys. In one or more examples, the decrypted receive data indicates an instruction to use, for key establishment, both the third public key and the selected one of the number of stored public keys identified by the identifier. At an act 406, the device derives a second shared session key at least partially based on the third public key and the selected one of the number of stored public keys identified by the identifier. At an act 408, the device encrypts transmit data of a second message to the communication device. The transmit data are encrypted using the second shared session key.

In one or more examples, the device stores the third public key with the number of stored public keys. The device decrypts receive data of a third message from the communication device. The receive data are decrypted using the second shared session key. The decrypted receive data include a fourth public key and an identifier to identify another selected one of the number of stored public keys. The device derives a third shared session key at least partially based on the fourth public key and the other selected one of the number of stored public keys identified by the identifier. The device encrypts transmit data of a fourth message to the communication device. The transmit data are encrypted using the third shared session key.

In one or more examples, the device derives the second shared session key including to generate an ephemeral private key and an ephemeral public key of an ephemeral public-private key pair; generate a first shared secret based on a key agreement function using, as inputs, at least the ephemeral private key and the third public key; generate a second shared secret based on the key agreement function using, as inputs, at least the ephemeral private key and the selected one of the number of stored public keys as identified by the identifier; and derive the second shared session key based on a key derivation function using, as inputs, at least the first shared secret and the second shared secret.

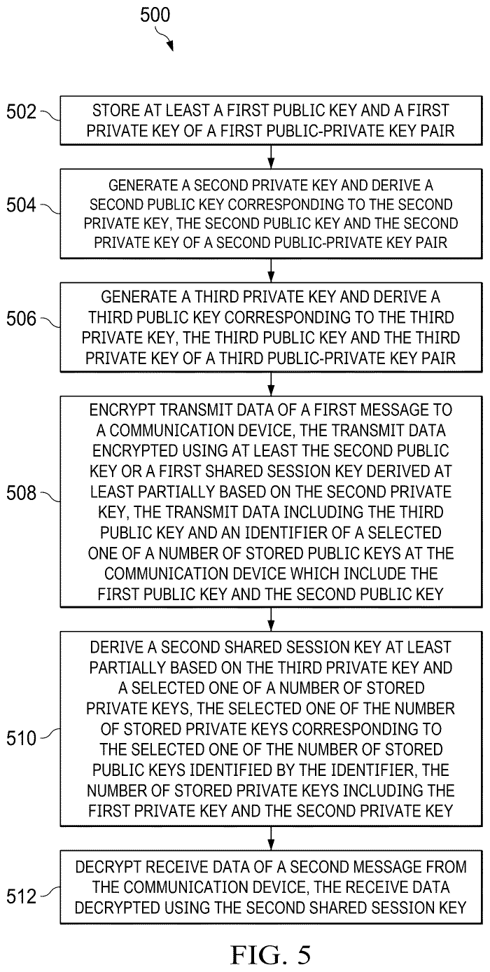

FIG. 5 is a flowchart of a method 500 of performing cryptographic communications, in one or more examples. Method 500 of FIG. 5 may be performed at a communication device, such as device 302 of FIGS. 3A, 3B, 3C, 3D, 3E, 3F, 3G, and 3H. Although method 500 of FIG. 5 is described as being performed at device 302, it may be alternatively or additionally performed at device 304 of FIGS. 3A, 3B, 3C, 3D, 3E, 3F, 3G, and 3H. In one or more examples, the device used for method 500 of FIG. 5 may include one or more processors, one or more memories operably coupled to the one or more processors, and a transceiver (e.g., an RF or wireless transceiver) operably coupled to the one or more processors. The one or more processors may include a host processor and both a secure processor and a cryptographic processor of a secure element, where the secure element further includes a random key generator and a key store.

At an act 502, the device stores at least a first public key and a first private key of a first public-private key pair. At an act 504, the device generates a second private key and derives a second public key corresponding to the second private key, the second public key and the second private key being of a second public-private key pair. At an act 506, the device generates a third private key and derives a third public key corresponding to the third private key, the third public key and the third private key being of a third public-private key pair.

At an act 508, the device encrypts transmit data of a first message to a communication device. The transmit data are encrypted using at least the second public key. Alternatively, the transmit data are encrypted using a first shared session key derived at least partially based on the second private key. The transmit data include the third public key and an identifier of a selected one of a number of stored public keys at the communication device which include the first public key and the second public key. In one or more examples, the device selects the selected one of the number of stored public keys randomly, pseudo-randomly, or deterministically. In one or more examples, the transmit data indicates an instruction to use, for key establishment of the second shared session key, both the third public key and the selected one of the number of stored public keys identified by the identifier.

In one or more examples, the transmit data of the first message are encrypted using the first shared session key. At an act 510, the device derives a second shared session key at least partially based on the third private key and a selected one of a number of stored private keys. The selected one of the number of stored private keys corresponds to the selected one of the number of stored public keys identified by the identifier. The number of stored private keys includes the first private key and the second private key. At an act 512, the device decrypts receive data of a second message from the communication device. The receive data are decrypted using the second shared session key.

In one or more examples, the device derives the second shared session key including to generate a first shared secret based on a key agreement function using, as inputs, at least the third private key and an ephemeral public key received from the communication device; generate a second shared secret based on the key agreement function using, as inputs, at least the selected one of the number of stored private keys and the ephemeral public key received from the communication device; and derive the third shared session key based on a key derivation function using, as inputs, at least the first shared secret and the second shared secret.

FIG. 6 is a schematic diagram of a communication device 600 (a “device 600”), according to one or more examples. In one or more examples, device 600 may be used to perform processing acts associated with FIGS. 1A, 1B, 1C, 1D, 1E, 1F, 1G, 1H, 1I, and 1J, acts of method 200 of FIG. 2, processing acts associated with FIGS. 3A, 3B, 3C, 3D, 3E, 3F, 3G, and 3H, acts of method 400 of FIG. 4, and acts of method 500 of FIG. 5.

Device 600 of FIG. 6 includes one or more processors 601, one or more memories 608 operably coupled to one or more processors 601, a transceiver 604 (e.g., an RF or wireless transceiver) operably coupled to one or more processors 601, and an antenna 606 coupled to transceiver 604. One or more processors 601 operate transceiver 604 to communicate (e.g., RF or wirelessly communicate) messages via antenna 606. Device 600 also includes a secure element 610 including a random key generator 612, a key store 614, and a cryptographic engine 616. One or more processors 601 include a host processor 602. One or more processors 601 may further include both a secure processor of secure element 610 and cryptographic engine 616 of secure element 610. Secure element 610 utilizes random key generator 612 and cryptographic engine 616 to randomly generate private keys and derive corresponding public keys of public-private key pairs which are stored in key store 614 (e.g., in key slots, and/or identified by key IDs). In one or more examples, all keys (both public and private keys) are stored in key store 614. In one or more alternative examples, one or more memories 608 may include a list or table 618 of stored public keys. Cryptographic engine 616 may be used to encrypt and decrypt data of messages communicated via transceiver 604.

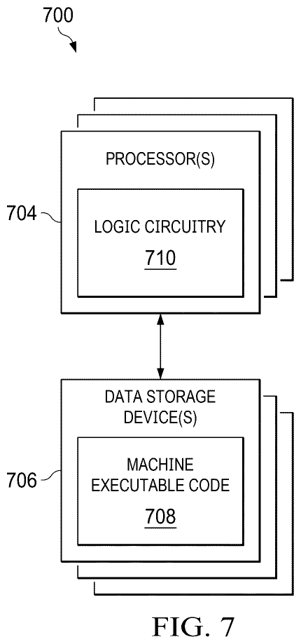

FIG. 7 is a block diagram of circuitry 700 that, in some examples, may be used to implement various functions, operations, acts, processes, and/or methods disclosed herein. Circuitry 700 includes one or more processors 704 (sometimes referred to herein as “processor 704”) operably coupled to one or more data storage devices (sometimes referred to herein as “storage 706”). Storage 706 includes machine-executable code 708 stored thereon, and processor 704 include a logic circuitry 710. Machine-executable code 708 includes information describing functional elements that may be implemented by (e.g., performed by) logic circuitry 710. Logic circuitry 710 is adapted to implement (e.g., perform) the functional elements described by machine-executable code 708. Circuitry 700, when executing the functional elements described by machine-executable code 708, should be considered as special purpose hardware for carrying out functional elements disclosed herein. In some examples, processor 704 may perform the functional elements described by machine-executable code 708 sequentially, concurrently (e.g., on one or more different hardware platforms), or in one or more parallel process streams.

When implemented by logic circuitry 710 of processor 704, machine-executable code 708 adapts processor 704 to perform operations of examples disclosed herein. For example, machine-executable code 708 may be to adapt processor 704 to perform at least a portion or a totality of methods or processes described herein (e.g., method 200 of FIG. 2, method 400 of FIG. 4, method 500 of FIG. 5, processing acts associated with FIGS. 1A, 1B, 1C, 1D, 1E, 1F, 1G, 1H, 1I, and 1J, and/or processing acts associated with FIGS. 3A, 3B, 3C, 3D, 3E, 3F, 3G, and 3H). In one or more examples, processor 704 may be adapted to control a secure element (e.g., secure element 610 of FIG. 6) that operates to perform at least some of the processing acts of the methods (e.g., using the secure processor and cryptographic engine 616 within secure element 610).

Processor 704 may include a general purpose processor, a special purpose processor, a central processing unit (CPU), a microcontroller, a programmable logic controller (PLC), a DSP, an application specific integrated circuit (ASIC), a FPGA or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to machine-executable code 708 (e.g., software code, firmware code, hardware descriptions) related to examples of the present disclosure. It is noted that a general-purpose processor (may also be referred to herein as a host processor or simply a host) may be a microprocessor, but in the alternative, processor 704 may include any conventional processor, controller, microcontroller, or state machine. Processor 704 may also be implemented as a combination of computing devices, such as a combination of a DSP and a microprocessor, a plurality of microprocessors, one or more microprocessors in conjunction with a DSP core, or any other such configuration.

In some examples, storage 706 includes volatile data storage (e.g., random-access memory (RAM)), non-volatile data storage (e.g., Flash memory, a hard disc drive, a solid-state drive, erasable programmable read-only memory (EPROM), etc.). In some examples, processor 704 and storage 706 may be implemented into a single device (e.g., a semiconductor device product, a system on chip (SOC), etc.). In some examples, processor 704 and storage 706 may be implemented into separate devices.

In some examples, machine-executable code 708 may include computer-readable instructions (e.g., software code, firmware code). By way of non-limiting example, the computer-readable instructions may be stored by storage 706, accessed directly by processor 704, and executed by processor 704 using at least logic circuitry 710. Also by way of non-limiting example, the computer-readable instructions may be stored on storage 706, transferred to a memory device (not shown) for execution, and executed by processor 704 using at least the logic circuitry 710. Accordingly, in some examples, logic circuitry 710 includes electrically configurable logic circuitry 710.

In some examples, machine-executable code 708 may describe hardware (e.g., circuitry) to be implemented in logic circuitry 710 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog, and/or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuitries (e.g., gates, flip-flops, registers, without limitation) of logic circuitry 710 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine-executable code 708 may include an HDL, an RTL, a GL description, a mask level description, other hardware description, or any combination thereof.

In examples where machine-executable code 708 includes a hardware description (at any level of abstraction), a system (not shown, but including storage 706) may be to implement the hardware description described by machine-executable code 708. By way of non-limiting example, processor 704 may include a programmable logic device (e.g., an FPGA or a PLC) and logic circuitry 710 may be electrically controlled to implement circuitry corresponding to the hardware description into logic circuitry 710. Also by way of non-limiting example, logic circuitry 710 may include hard-wired logic manufactured by a manufacturing system (not shown, but including storage 706) according to the hardware description of machine-executable code 708.

Regardless of whether machine-executable code 708 includes computer-readable instructions or a hardware description, logic circuitry 710 is adapted to perform the functional elements described by machine-executable code 708 when implementing the functional elements of machine-executable code 708. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc. ,” or “one or more of A, B, and C, etc. ,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Example 1: A method comprising: storing a first public key and a first private key of a first public-private key pair; generating a second private key using a random key generator and deriving a second public key based on the second private key, the second public key and the second private key of a second public-private key pair; encrypting transmit data of a first message to a communication device, the transmit data encrypted using at least the first public key or a first shared session key derived at least partially based on the first private key, the transmit data including the second public key; and decrypting receive data of a second message from the communication device, the receive data decrypted using at least the second private key or a second shared session key derived at least partially based on the second private key.

Example 2: The method according to Example 1, comprising: generating a third private key using the random key generator and deriving a third public key based on the third private key, the third public key and the third private key of a third public-private key pair; and encrypting transmit data of a third message to the communication device, the transmit data encrypted using at least the second public key or the second shared session key, the transmit data including the third public key.

Example 3: The method according to Examples 1 and 2, comprising: decrypting receive data of a fourth message from the communication device, the receive data decrypted using at least the third private key or a third shared session key derived at least partially based on the third private key.

Example 4: The method according to any of Examples 1 through 3, wherein the transmit data of the first message is encrypted using the first shared session key, the receive data of the second message is decrypted using the second shared session key, the transmit data of the third message is encrypted using the second shared session key, and the receive data of the fourth message is decrypted using the third shared session key, and the method comprises deriving the second shared session key including: generating a shared secret based on a key agreement function using, as inputs, at least the second private key and an ephemeral public key received from the communication device; and deriving the second shared session key based on a key agreement function using, as an input, at least the shared secret.

Example 5: The method according to any of Examples 1 through 4, wherein the transmit data of the first message is encrypted using at least the first public key, the receive data of the second message is decrypted using at least the second private key, the transmit data of the third message is encrypted using at least the second public key, and the receive data of the fourth message is decrypted using at least the third private key, and wherein: encrypting the transmit data of the third message comprises encrypting the transmit data including the third public key and an identifier to identify a selected one of a number of stored public keys at the communication device, the number of stored public keys including the first public key and the second public key; and decrypting receive data of the fourth message comprises producing decrypted receive data, the decrypted receive data decrypted using both the third private key and a selected one of a number of stored private keys in accordance with a layered encryption/decryption protocol, the selected one of the number of stored private keys corresponding to the selected one of the number of stored public keys, the number of stored private keys including the first private key and the second private key.

Example 6: The method according to any of Examples 1 through 5, wherein the transmit data of the first message is encrypted using the first shared session key, the receive data of the second message is decrypted using the second shared session key, the transmit data of the third message is encrypted using the second shared session key, and the receive data of the fourth message is decrypted using the third shared session key, and wherein: encrypting the transmit data of the third message comprises encrypting the transmit data including the third public key and an identifier to identify a selected one of a number of stored public keys at the communication device, the number of stored public keys including the first public key and the second public key; and deriving the third shared session key at least partially based on the third private key and a selected one of a number of stored private keys, the selected one of the number of stored private keys corresponding to the selected one of the number of stored public keys, the number of stored private keys including the first private key and the second private key.

Example 7: The method according to any of Examples 1 through 6, wherein deriving the third shared session key comprises: generating a first shared secret based on a key agreement function using, as inputs, at least the third private key and an ephemeral public key received from the communication device; generating a second shared secret based on the key agreement function using, as inputs, at least the selected one of the number of stored private keys and the ephemeral public key received from the communication device; and deriving the third shared session key based on a key derivation function using, as inputs, at least the first shared secret and the second shared secret.

Example 8: The method according to any of Examples 1 through 7, comprising: selecting the selected one of the number of stored public keys randomly, pseudo-randomly, or deterministically.

Example 9: A device comprising: one or more processors; one or more memories operably coupled to the one or more processors, the one or more memories to store a number of public keys including at least a first public key and a second public key; a transceiver operably coupled to the one or more processors; and the one or more processors to: decrypt receive data of a first message from a communication device, the receive data decrypted using a first shared session key, the decrypted receive data including a third public key and an identifier to identify a selected one of the number of stored public keys; derive a second shared session key at least partially based on the third public key and the selected one of the number of stored public keys identified by the identifier; and encrypt transmit data of a second message to the communication device, the transmit data encrypted using the second shared session key.

Example 10: The device according to Example 9, wherein the decrypted receive data indicates an instruction to use, for key establishment of the second shared session key, both the third public key and the selected one of the number of stored public keys identified by the identifier.

Example 11: The device according to Examples 9 and 10, wherein the selected one of the number of stored public keys is randomly, pseudo-randomly, or deterministically selected from the number of stored public keys.

Example 12: The device according to any of Examples 9 through 11, wherein: the one or more processors to: store the third public key with the number of stored public keys; decrypt receive data of a third message from the communication device, the receive data decrypted using the second shared session key, the decrypted receive data including a fourth public key and an identifier to identify another selected one of the number of stored public keys; and derive a third shared session key at least partially based on the fourth public key and the other selected one of the number of stored public keys identified by the identifier; and encrypt transmit data of a fourth message to the communication device, the transmit data encrypted using the third shared session key.

Example 13: The device according to any of Examples 9 through 12, wherein: the one or more processors is to derive the second shared session key including to: generate an ephemeral private key and an ephemeral public key of an ephemeral public-private key pair; generate a first shared secret based on a key agreement function using, as inputs, at least the ephemeral private key and the third public key; generate a second shared secret based on the key agreement function using, as inputs, at least the ephemeral private key and the selected one of the number of stored public keys as identified by the identifier; and derive the second shared session key based on a key derivation function using, as inputs, at least the first shared secret and the second shared secret.

Example 14: The device according to any of Examples 9 through 13, wherein: the one or more processors comprise a host processor and both a secure processor and a cryptographic processor of a secure element, the secure element further including a random key generator and a key store.

Example 15: A device comprising: one or more processors; a transceiver operably coupled to the one or more processors; a secure element operably coupled to the one or more processors, the secure element including a random key generator, a cryptographic processor, and a key store, the key store to store at least a first public key and a first private key of a first public-private key pair; the one or more processors to control the secure element to: generate a second private key and derive a second public key corresponding to the second private key, the second public key and the second private key of a second public-private key pair; generate a third private key and derive a third public key corresponding to the third private key, the third public key and the third private key of a third public-private key pair; and encrypt transmit data of a first message to a communication device, the transmit data encrypted using at least the second public key or a first shared session key derived at least partially based on the second private key, the transmit data including the third public key and an identifier of a selected one of a number of stored public keys at the communication device which include the first public key and the second public key.

Example 16: The device according to Example 15, wherein the transmit data of the first message is encrypted using the first shared session key, and wherein: the one or more processors to control the secure element to: derive a second shared session key at least partially based on the third private key and a selected one of a number of stored private keys, the selected one of the number of stored private keys corresponding to the selected one of the number of stored public keys identified by the identifier, the number of stored private keys including the first private key and the second private key; and decrypting receive data of a second message from the communication device, the receive data decrypted using the second shared session key.

Example 17: The device according to Examples 15 and 16, wherein: the one or more processors is to control the secure element to encrypt the transmit data which indicates an instruction to use, for key establishment of the second shared session key, both the third public key and the selected one of the number of stored public keys identified by the identifier.

Example 18: The device according to any of Examples 15 through 17, wherein: the one or more processors is to select the selected one of the number of stored public keys randomly, pseudo-randomly, or deterministically.

Example 19: The device according to any of Examples 15 through 18, wherein: the one or more processors is to derive the second shared session key including to: generate a first shared secret based on a key agreement function using, as inputs, at least the third private key and an ephemeral public key received from the communication device; generate a second shared secret based on the key agreement function using, as inputs, at least the selected one of the number of stored private keys and the ephemeral public key received from the communication device; and derive the second shared session key based on a key derivation function using, as inputs, at least the first shared secret and the second shared secret.

Example 20: The device according to any of Examples 15 through 19, wherein the selected one of the number of stored private keys is the first private key or the second private key.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method comprising:
storing a first public key and a first private key of a first public-private key pair;
generating a second private key using a random key generator and deriving a second public key based on the second private key, the second public key and the second private key of a second public-private key pair;
encrypting transmit data of a first message to a communication device, the transmit data encrypted using at least the first public key or a first shared session key derived at least partially based on the first private key, the transmit data including the second public key; and
decrypting receive data of a second message from the communication device, the receive data decrypted using at least the second private key or a second shared session key derived at least partially based on the second private key.

2. The method of claim 1, comprising:
generating a third private key using the random key generator and deriving a third public key based on the third private key, the third public key and the third private key of a third public-private key pair; and
encrypting transmit data of a third message to the communication device, the transmit data encrypted using at least the second public key or the second shared session key, the transmit data including the third public key.

3. The method of claim 2, comprising:
decrypting receive data of a fourth message from the communication device, the receive data decrypted using at least the third private key or a third shared session key derived at least partially based on the third private key.

4. The method of claim 3, wherein the transmit data of the first message is encrypted using the first shared session key, the receive data of the second message is decrypted using the second shared session key, the transmit data of the third message is encrypted using the second shared session key, and the receive data of the fourth message is decrypted using the third shared session key, and the method comprises deriving the second shared session key including:
generating a shared secret based on a key agreement function using, as inputs, at least the second private key and an ephemeral public key received from the communication device; and
deriving the second shared session key based on a key agreement function using, as an input, at least the shared secret.

5. The method of claim 3, wherein the transmit data of the first message is encrypted using at least the first public key, the receive data of the second message is decrypted using at least the second private key, the transmit data of the third message is encrypted using at least the second public key, and the receive data of the fourth message is decrypted using at least the third private key, and wherein:
encrypting the transmit data of the third message comprises encrypting the transmit data including the third public key and an identifier to identify a selected one of a number of stored public keys at the communication device, the number of stored public keys including the first public key and the second public key; and
decrypting receive data of the fourth message comprises producing decrypted receive data, the decrypted receive data decrypted using both the third private key and a selected one of a number of stored private keys in accordance with a layered encryption/decryption protocol, the selected one of the number of stored private keys corresponding to the selected one of the number of stored public keys, the number of stored private keys including the first private key and the second private key.

6. The method of claim 3, wherein the transmit data of the first message is encrypted using the first shared session key, the receive data of the second message is decrypted using the second shared session key, the transmit data of the third message is encrypted using the second shared session key, and the receive data of the fourth message is decrypted using the third shared session key, and wherein:
encrypting the transmit data of the third message comprises encrypting the transmit data including the third public key and an identifier to identify a selected one of a number of stored public keys at the communication device, the number of stored public keys including the first public key and the second public key; and
deriving the third shared session key at least partially based on the third private key and a selected one of a number of stored private keys, the selected one of the number of stored private keys corresponding to the selected one of the number of stored public keys, the number of stored private keys including the first private key and the second private key.

7. The method of claim 6, wherein deriving the third shared session key comprises:
generating a first shared secret based on a key agreement function using, as inputs, at least the third private key and an ephemeral public key received from the communication device;
generating a second shared secret based on the key agreement function using, as inputs, at least the selected one of the number of stored private keys and the ephemeral public key received from the communication device; and
deriving the third shared session key based on a key derivation function using, as inputs, at least the first shared secret and the second shared secret.

8. The method of claim 6, comprising:
selecting the selected one of the number of stored public keys randomly, pseudo-randomly, or deterministically.

9. A device comprising:
one or more processors;
one or more memories operably coupled to the one or more processors, the one or more memories to store a number of public keys including at least a first public key and a second public key;
a transceiver operably coupled to the one or more processors; and
the one or more processors to:
decrypt receive data of a first message from a communication device, the receive data decrypted using a first shared session key, the decrypted receive data including a third public key and an identifier to identify a selected one of the number of stored public keys;
derive a second shared session key at least partially based on the third public key and the selected one of the number of stored public keys identified by the identifier; and
encrypt transmit data of a second message to the communication device, the transmit data encrypted using the second shared session key.

10. The device of claim 9, wherein the decrypted receive data indicates an instruction to use, for key establishment of the second shared session key, both the third public key and the selected one of the number of stored public keys identified by the identifier.

11. The device of claim 10, wherein the selected one of the number of stored public keys is randomly, pseudo-randomly, or deterministically selected from the number of stored public keys.

12. The device of claim 9, wherein:
the one or more processors to:
store the third public key with the number of stored public keys;
decrypt receive data of a third message from the communication device, the receive data decrypted using the second shared session key, the decrypted receive data including a fourth public key and an identifier to identify another selected one of the number of stored public keys; and
derive a third shared session key at least partially based on the fourth public key and the other selected one of the number of stored public keys identified by the identifier; and
encrypt transmit data of a fourth message to the communication device, the transmit data encrypted using the third shared session key.

13. The device of claim 9, wherein:
the one or more processors is to derive the second shared session key including to:
generate an ephemeral private key and an ephemeral public key of an ephemeral public-private key pair;
generate a first shared secret based on a key agreement function using, as inputs, at least the ephemeral private key and the third public key;
generate a second shared secret based on the key agreement function using, as inputs, at least the ephemeral private key and the selected one of the number of stored public keys as identified by the identifier; and
derive the second shared session key based on a key derivation function using, as inputs, at least the first shared secret and the second shared secret.

14. The device of claim 9, wherein:
the one or more processors comprise a host processor and both a secure processor and a cryptographic processor of a secure element, the secure element further including a random key generator and a key store.

15. A device comprising:
one or more processors;
a transceiver operably coupled to the one or more processors;
a secure element operably coupled to the one or more processors, the secure element including a random key generator, a cryptographic processor, and a key store, the key store to store at least a first public key and a first private key of a first public-private key pair;
the one or more processors to control the secure element to:
generate a second private key and derive a second public key corresponding to the second private key, the second public key and the second private key of a second public-private key pair;
generate a third private key and derive a third public key corresponding to the third private key, the third public key and the third private key of a third public-private key pair; and
encrypt transmit data of a first message to a communication device, the transmit data encrypted using at least the second public key or a first shared session key derived at least partially based on the second private key, the transmit data including the third public key and an identifier of a selected one of a number of stored public keys at the communication device which include the first public key and the second public key.

16. The device of claim 15, wherein the transmit data of the first message is encrypted using the first shared session key, and wherein:
the one or more processors to control the secure element to:
derive a second shared session key at least partially based on the third private key and a selected one of a number of stored private keys, the selected one of the number of stored private keys corresponding to the selected one of the number of stored public keys identified by the identifier, the number of stored private keys including the first private key and the second private key; and
decrypting receive data of a second message from the communication device, the receive data decrypted using the second shared session key.

17. The device of claim 16, wherein:
the one or more processors is to control the secure element to encrypt the transmit data which indicates an instruction to use, for key establishment of the second shared session key, both the third public key and the selected one of the number of stored public keys identified by the identifier.

18. The device of claim 16, wherein:
the one or more processors is to select the selected one of the number of stored public keys randomly, pseudo-randomly, or deterministically.

19. The device of claim 16, wherein:
the one or more processors is to derive the second shared session key including to:
generate a first shared secret based on a key agreement function using, as inputs, at least the third private key and an ephemeral public key received from the communication device;
generate a second shared secret based on the key agreement function using, as inputs, at least the selected one of the number of stored private keys and the ephemeral public key received from the communication device; and
derive the second shared session key based on a key derivation function using, as inputs, at least the first shared secret and the second shared secret.

20. The device of claim 16, wherein the selected one of the number of stored private keys is the first private key or the second private key.
